(19) United States
(12) Patent Application Publication
(10) Pub. No.: US 2018/0172979 A1
(43) Pub. Date: Jun. 21, 2018

(54) OPTICAL FILM AND USER INPUT SYSTEM

(71) Applicant: CHI HSIANG OPTICS CO., LTD., Zhubei City (TW)

(72) Inventor: Po-Hung YAO, Hsinchu City (TW)

(21) Appl. No.: 15/844,218

(22) Filed: Dec. 15, 2017

(30) Foreign Application Priority Data
Dec. 16, 2016 (TW) 105141699

(51) Int. Cl. G02B 26/06; G02B 1/115; G06F 3/0354; G06F 3/042

(52) U.S. Cl. CPC G02B 26/06; G06F 3/0421; G06F 3/03545; G02B 1/115

(57) ABSTRACT

An optical film includes a substrate and a phase compensation layer. The substrate has a sensing surface and an opposite back surface. The phase compensation layer is disposed on at least one of the sensing surface and the back surface of the substrate to reflect or transmit a sensing light with a particular phase, wherein the phase compensation layer includes a coding pattern and the coding pattern includes coded information. The foregoing optical film has no optical phase compensation for natural light in an environment, so that the optical film has high transmittance of the natural light. A user input system including the foregoing optical film is also disclosed.

### BACKGROUND OF THE INVENTION

### 1. Field of the Invention

The present invention relates to an optical film and a user input system, particularly to an optical film and a user input system allowing the user to input data with an optical reading device.

### 2. Description of the Prior Art

In a user input system, the substrate thereof has a coding pattern including addressing information. The user uses an appropriate reading device to read the addressing information of the coding pattern, whereby to record the track of the reading device moving on the surface of the substrate. In general, the reading device is a stylus-like structure enabling the user to interact with the electronic device in a usual writing way. The conventional coding pattern is normally made of an optical material able to absorb or reflect the light with a specified wavelength. However, the optical materials are likely to decrease the transparency or lucidity of the transparent substrate or shift the color tones of the transparent substrate.

Therefore, an optical film containing a coding pattern and having high transparency is the target the manufacturers are eager to achieve.

### SUMMARY OF THE INVENTION

The primary objective of the present invention is to provide an optical film and a user input system, which use a phase compensation layer to form optical phase compensation variation to generate a desired coding pattern. The phase compensation layer has no optical phase compensation effect for natural light. Therefore, the optical film and user input system of the present invention has a higher transmittance of natural light and thus has a higher transparency.

In one embodiment, the optical film of the present invention comprises a substrate and a phase compensation layer. The substrate has a sensing surface and a back surface opposite to the sensing surface. The phase compensation layer is disposed on at least one of the sensing surface and the back surface, transmitting or reflecting a sensing light with a specified phase. The phase compensation layer has a coding pattern, and the coding pattern has coded information.

In one embodiment, the user input system of the present invention comprises an optical film and an optical reading device. The optical film includes a substrate and a phase compensation layer. The substrate has a sensing surface and a back surface opposite to the sensing surface. The phase compensation layer is disposed on at least one of the sensing surface and the back surface, transmitting or reflecting a sensing light with a specified phase. The phase compensation layer has a coding pattern, and the coding pattern has coded information. The optical reading device has a touch end used to press against the sensing surface of the optical film. The optical reading device includes a light source module, an image sensor, a phase selector, a processing unit, and a communication interface. The light source module generates a sensing light with a specified phase to illuminate the optical film. The image sensor detects the sensing light with a specified phase, which comes from the phase compensation layer, and outputs a sensed image. The phase selector is disposed on a light entrance side of the image sensor, allowing the sensing light with a specified phase to pass. The processing unit is electrically connected with the image sensor, analyzing the sensed mage to obtain the coded information of the coding pattern. The communication interface is electrically connected with the processing unit, sending the coded information to an external electronic device.

Below, embodiments are described in detail in cooperation with the attached drawings to make easily understood the objectives, technical contents, characteristics, and accomplishments of the present invention.

### BRIEF DESCRIPTION OF THE DRAWINGS

FIG. 1 is a diagram schematically showing an optical film according to a first embodiment of the present invention;

FIG. 2 is a diagram schematically showing an optical film according to a second embodiment of the present invention;

FIG. 3 is a diagram schematically showing an optical film according to a third embodiment of the present invention;

FIG. 4 is a diagram schematically showing an optical film according to a fourth embodiment of the present invention;

FIG. 5 is a diagram schematically showing a user input system according to one embodiment of the present invention;

FIG. 6 is a diagram schematically showing an optical reading device of a user input system according to one embodiment of the present invention;

FIG. 7 is a diagram schematically showing a configuration of a coding pattern according to one embodiment of the present invention; and

FIG. 8 is a diagram schematically showing a configuration of a coding pattern according to another embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

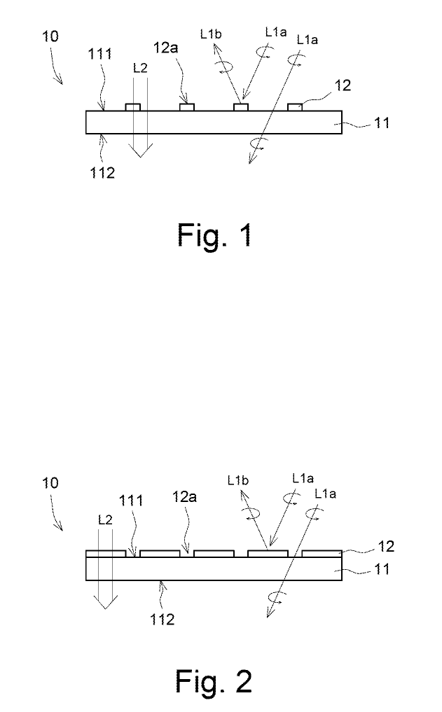

Refer to FIG. 1. In one embodiment, the optical film 10 of the present invention comprises a substrate 11 and a phase compensation layer 12. The substrate 11 has a sensing surface 111 and a back surface 112 opposite to the sensing surface 111. In one embodiment, the substrate 11 is made of a material selected from a group including polyethylene terephthalate (PET), polycarbonate (PC), polymethylmethacrylate (PMMA), polyimide (PI), cellulose triacetate (TAC), cyclic olefin polymer (COP) and a PC-PMMA composite film.

The phase compensation layer 12 is disposed on at least one of the sensing surface 111 and the back surface 112 of the substrate 11. In the embodiment shown in FIG. 1, the phase compensation layer 12 is disposed on the sensing surface 111 of the substrate 11. The phase compensation layer 12 may reflect or transmit a sensing light with a specified phase. For example, the sensing light may be a right circularly-polarized light, a left circularly-polarized light, a horizontal linearly-polarized light, or a vertical linearly-polarized light. In one embodiment, the sensing light L1 is an invisible light, such as an infrared light or an ultraviolet light. In one embodiment, the substrate 11 and the phase compensation layer 12 allow a visible light L2 to pass. Thus, the optical film 10 of the present invention can apply to display devices. In other words, the visible light image presented by the display device can penetrate the optical film 10 of the present invention. The phase compensation layer 12 includes a coding pattern 12a. For example, the coding pattern 12a has a plurality of pattern units, and the pattern units may be lines, circles, ellipses, polygons, curves, or a combination thereof. It is preferred: the long axis and short axis of each pattern unit are different in length. Thereby, the orientation (rotation angle) of a pattern unit can be determined. It is easily understood: the coding pattern 12a has coded information. The coded information may be at least one of addressing information, text information, graphic information, instruction information, and counterfeit-proof information.

In one embodiment, the phase compensation layer 12 is realized by a liquid crystal polymer, a multilayer structure, a nanograting structure, or segmented fiber. Refer to FIG. 1 again. For example, a circularly-polarized cholesterol-based liquid crystal material is attached to the sensing surface 111 of the substrate 11 through the coating/inject printing and photo-alignment processes to form the coding pattern 12a. While a right circularly-polarized sensing light L1a is incident to the optical film 10 of the present invention, the sensing light L1a illuminating the coding pattern 12a is reflected into a left circularly-polarized sensing light L1b by the optical phase compensation effect and the reflective rotation effect of the coding pattern 12a. The sensing light L1a not illuminating the coding pattern 12a penetrates the optical film 10. The optical reading device receives the reflected sensing light L1b to form the light-state coding pattern 12a, and the coding pattern 12a will be decoded later.

Refer to FIG. 2. In one embodiment, the coding pattern 12a is defined by a perforated area of the phase compensation layer 12. In other words, the coding pattern 12a does not reflect the sensing light L1a. What the optical reading device receives is the sensing light L1b reflected by the area outside the coding pattern 12a. Thus is formed a dark-state coding pattern 12a. In other words, the coding pattern 12a of the phase compensation layer 12 and the area outside the coding pattern 12a respectively apply different phase compensation actions to the incident sensing light L1a. Thus, the optical reading device can distinguish the results of different phase compensation actions, recognize the coding pattern 12a, and decode the coding pattern 12a later.

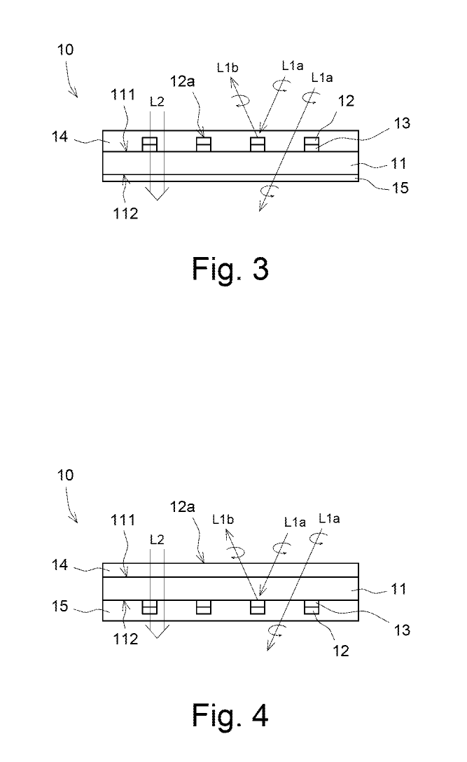

Refer to FIG. 3. In one embodiment, the optical film 10 further comprises a scattering layer 13. In this embodiment, the scattering layer 13 is disposed between the substrate 11 and the phase compensation layer 12. However, the present invention is not limited by this embodiment. In one embodiment, the scattering layer 13 is disposed on the phase compensation layer 12, i.e. the phase compensation layer 12 is disposed between the substrate 11 and the scattering layer 13. The scattering layer 13 scatters the sensing light L1b, which is reflected by the optical film 10 or penetrates the optical film 10, to soften the sensing light L1b or homogenize the intensity of the sensing light L1b, and broaden the area of receiving the light signal. In one embodiment, the scattering layer 13 is a roughened surface, such as the roughened sensing surface 111 or back surface 112 of the substrate 11. For example, the scattering layer 13 has a surface roughness of greater than 25 nm. In one embodiment, the scattering layer 13 is a combination of a polymer and a plurality of scattering tiny particles distributed in the polymer. The scattering tiny particles may be micron/nanometric metal/metal oxide particles or polymer particles having a refractivity different from that of the polymer. In one embodiment, the scattering layer 13 is realized by a holographic structure.

Refer to FIG. 3 again. In one embodiment, the optical film 10 further comprises a coating layer 14. The coating layer 14 covers the phase compensation layer 12. The coating layer 14 can prevent the phase compensation layer 12 from being abraded by the optical reading device frequently touching the phase compensation layer 12. It is easily understood: the coating layer 14 may be a multilayer structure. In one embodiment, the refractivity of the coating layer 14 is identical to or different from that of the substrate 11. It is preferred: the coating layer 14 has at least one of a hard coating property, an anti-glare property, an anti-reflection property, an anti-fingerprint property, a hydrophobicity property, and an anti-electrostatic property. Refer to FIG. 4. It is easily understood: while the phase compensation layer 12 is disposed on the back surface 112 of the substrate 11, the coating layer 14 is disposed on the sensing surface 111 of the substrate 11.

Refer to FIG. 3 again. In one embodiment, the optical film 10 further comprises an adhesive layer 15. The adhesive layer 15 is disposed on the back surface 112 of the substrate 11. It is easily understood: while the phase compensation layer 12 is disposed on the back surface 112 of the substrate 11, the adhesive layer 15 covers the phase compensation layer 12, as shown in FIG. 4. Thereby, the optical film 10 of the present invention can be attached to an appropriate operation surface, such as the surface of a display device or a whiteboard. In one embodiment, the adhesive layer 15 has a high transparency. For example, the adhesive layer 15 has a light transmittance of greater than 70%. In one embodiment, the adhesive layer 15 includes a light absorption material able to absorb or scatter the light having a specified range of wavelengths, such as a dye or another light absorption agent, so as to satisfy practical requirement. In one embodiment, a blue dye is added to the adhesive layer 15 to modify the tone of the optical film 10. In one embodiment, a light absorption material is added to the adhesive layer 15 to absorb the light, which is incident to the back surface 112 of the substrate 11 from the environment and has a specified range of wavelengths, lest the incident environmental light hinder the optical reading device from recognizing the coding pattern 12a. In one embodiment, the adhesive layer 15 includes a plurality of micron or nanometric particles of a metal, a ceramic, a metal oxide, or a semiconductor oxide.

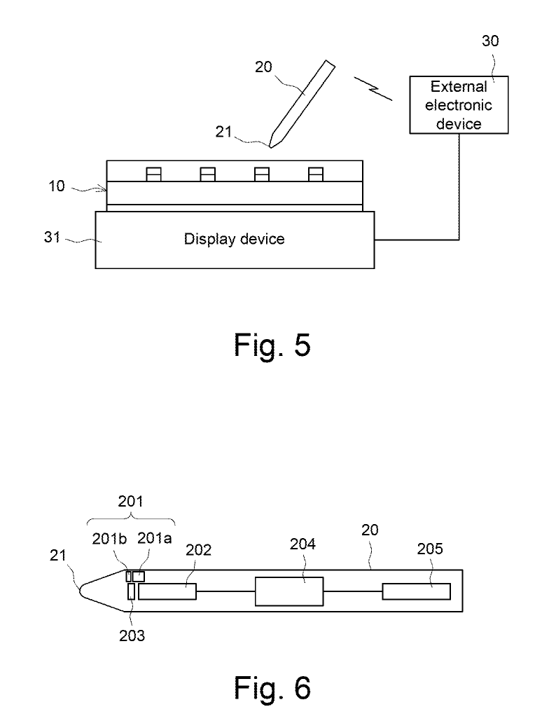

Refer to FIG. 5 and FIG. 6. In one embodiment, the user input system of the present invention comprises an optical film 10 and an optical reading device 20. The detailed structure of the optical film 10 has been shown in FIG. 3 and will not repeat herein. The optical reading device 20 has a touch end 21 used to press against the sensing surface 111 of the optical film 10 to enable the user to interact with the electronic device in a usual writing way. The optical reading device 20 comprises a light source module 201, an image sensor 202, a phase selector 203, a processing unit 204, and a communication interface 205.

The light source module 201 includes a light emitting unit 201a and a polarizer 201b. The polarizer 201b is disposed on a light output side of the light emitting unit 201a. The light emitting unit 201a may be an infrared light emitting diode or an ultraviolet light emitting diode. It is preferred: the light emitting unit 201a is an infrared light emitting diode. The polarizer 201b converts the light emitted by the light emitting unit 201a into a sensing light having a specified phase, such as a right circularly-polarized light, a left circularly-polarized light, a horizontal linearly-polarized light, a vertical linearly-polarized light, or another polarized light. While the light source module 201 generates a sensing light having a specified phase to illuminate the optical film 10, a corresponding sensing light having a specified phase is reflected from the optical film 10 or penetrates the optical film 10. For an example, the right circularly-polarized light is reflected by the optical film 10 into a left circularly-polarized light under the phase compensation effect of the phase compensation layer 12. For another example, a horizontal linearly-polarized light is still a horizontal linearly-polarized light under the phase compensation effect of the phase compensation layer 12. For a further example, a vertical linearly-polarized light is still a vertical linearly-polarized light under the phase compensation effect of the phase compensation layer 12.

The image sensor 202 detects the sensing light, which comes from the phase compensation layer 12 and has a specified phase, and outputs a sensed mage. In one embodiment, the image sensor 202 includes a lens and a charge coupled device (CCD)/complementary metal oxide semiconductor (CMOS) sensor. In one embodiment, the lens is fabricated with poly methyl methacrylate (PMMA) in an injection-molding method. PMMA is abrasion-resistant and has a transmittance of about 90% for the light having a wavelength of 810 nm. In one embodiment, the size of the CCD or CMOS sensor is 128×128 pixels. In one embodiment, the CCD or CMOS sensor is fabricated to have a size of is 140×140 pixels so as to have a higher fabrication tolerance. The phase selector 203 is disposed on the light entrance side of the image sensor 202. The phase selector 203 only allows the sensing light coming from the phase compensation layer 12 and having a specified phase to pass, whereby the image sensor 202 can only receive the sensing light having a specified phase to form a sensed image containing the coding pattern.

The processing unit 204 is electrically connected with the image sensor 202. The processing unit 204 analyzes the sensed image to acquire the coded information of the coding pattern, such as addressing information, text information, graphic information, instruction information, or counterfeit-proof information. The communication interface 205 is electrically connected with the processing unit 204. The communication interface 205 transmits to an external electronic device 30 the coded information acquired by the processing unit 204, such as addressing information, text information, graphic information, instruction information, or counterfeit-proof information. In one embodiment, the communication interface 205 is a wireless communication interface or a wired communication interface. It is preferred: the communication interface 205 is a wireless communication interface lest the cords interfere with the writing activity of the user. For example, the wireless communication interface 205 may be based on the Bluetooth technology, the wireless local area network (WLAN) technology, the ZigBee communication technology, the wireless USB technology, or the mobile communication technology. It is easily understood: while not connected with the external electronic device 30, the optical reading device 20 can store the acquired coded information in the built-in memory, such as a flash memory. Once connected with the external electronic device 30, the optical reading device 20 can transmit the stored coded information to the external electronic device 30.

In one embodiment, the user input system of the present invention further comprises a display device 31. The display device 31 is disposed on the back side of the optical film 10. In other words, the optical film 10 is disposed on the display screen of the display device 31. The display device 31 is electrically connected with the external electronic device 30. Thereby, the external electronic device 30 can present the coded information, which is acquired from the optical reading device 20, on the display device 31 in real time. For an example, the user uses the optical reading device 20 to sign or draw on the optical film 10 of the present invention, and the external electronic device 30 presents the signature or drawing on the display device 30 instantly. For another example, the user uses the optical reading device 20 to click on a special area and decode the corresponding control instruction to undertake the operation of selection, page down, scroll, etc.

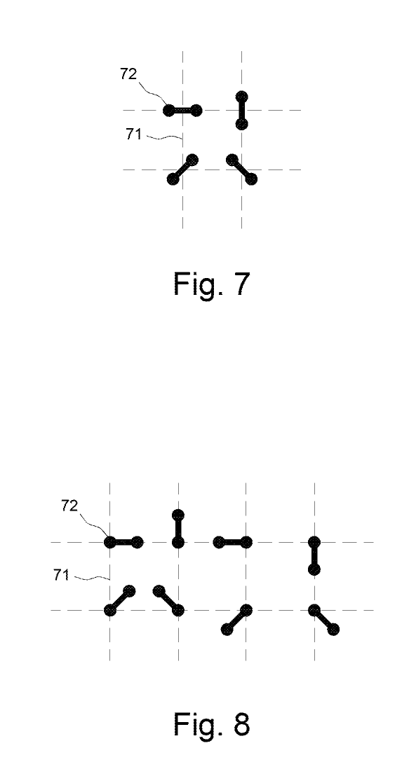

Refer to FIG. 7. In one embodiment, the coding pattern includes a virtual grid 71 and a plurality of pattern units 72. As the virtual grid 71 is not really drawn in the optical film 10, it is depicted with dashed lines. In the virtual grid 71, the dashed lines intersect vertically to form a plurality of intersection points. The coded information, such as addressing information, text information, graphic information, instruction information, or counterfeit-proof information, is coded using the relative positions of the pattern units 72 to the intersection points of the virtual grid 71. In the embodiment shown in FIG. 7, the pattern unit 72 is formed by a segment and circles, and the center of the pattern unit 72 is located at the intersection point of the virtual grid 71. In FIG. 7, the pattern units 72, which are respectively horizontal, vertical, tilted left by 45 degrees and tilted right by 45 degrees, separately represent four code values. Thereby, the information can be coded with the pattern units 72. It is easily understood: the sets formed by a plurality of pattern units 72 can be used to code more information.

Refer to FIG. 8. In one embodiment, the ends of pattern units 72 are located at the intersection points of the grid 71. In FIG. 8, the pattern units 72, which respectively rotate by 0, 45, 90, 135, 180, 270 and 315 degrees, separately represent eight code values. The coding method has been a technology well known by the persons with ordinary knowledge in the field. Further, the coding method is not the focus of the present invention. Therefore, it will not repeat herein. The present invention does not particularly limit that the information must be coded with a special method. In addition to the coding methods mentioned above, the information can also be coded in other appropriate methods.

In conclusion, the present invention proposes an optical film and a user input system, which use a phase compensation layer to generate optical phase compensation variation to form the required coding pattern. The phase compensation layer does not generate a significant optical modulation effect to natural light. In other words, the actions of the phase compensation layer to the natural lights respectively incident to the coding pattern and the area outside the coding pattern are identical or almost identical. Therefore, the optical film and the user input system of the present invention have a higher transmittance of natural light, i.e. a higher transparency, and feature lower tone shift.

What is claimed is:

1. An optical film comprising:
a substrate having a sensing surface and a back surface opposite to the sensing surface; and
a phase compensation layer disposed on at least one of the sensing surface and the back surface of the substrate, reflecting or transmitting a sensing light with a specified phase, and including a coding pattern having coded information.

2. The optical film according to claim 1, wherein the phase compensation layer is realized by a liquid crystal polymer, a multilayer structure, a nanograting structure, or segmented fiber.

3. The optical film according to claim 1, wherein the coding pattern comprises a plurality of pattern units, and the pattern units comprise lines, circles, ellipses, polygons, curves, or a combination thereof.

4. The optical film according to claim 1 further comprising:
a scattering layer disposed between the substrate and the phase compensation layer or disposed on the phase compensation layer for scattering the sensing light.

5. The optical film according to claim 4, wherein the scattering layer is realized by a roughened surface structure, a holographic structure, or scattering tiny particles.

6. The optical film according to claim 1 further comprising:
a coating layer covering the phase compensation layer or the sensing surface of the substrate, and having at least one of a hard coating property, an anti-glare property, an anti-reflection property, an anti-fingerprint property, a hydrophobicity property, and an anti-electrostatic property.

7. The optical film according to claim 1 further comprising
an adhesive layer disposed on an outermost side of the back surface of the substrate.

8. The optical film according to claim 7, wherein the adhesive layer includes a light absorption material able to absorb or scatter a light with a specified range of wavelengths.

9. A user input system comprising:
an optical film including:
a substrate having a sensing surface and a back surface opposite to the sensing surface; and
a phase compensation layer disposed on at least one of the sensing surface and the back surface of the substrate, reflecting or transmitting a sensing light with a specified phase, and including a coding pattern having coded information; and
an optical reading device having a touch end used to press against the sensing surface of the optical film and including:
a light source module generating the sensing light with the specified phase to illuminate the optical film;
an image sensor detecting the sensing light with the specified phase, which comes from the phase compensation layer, and outputting a sensed image;
a phase selector disposed on a light entrance side of the image sensor and allowing the sensing light with the specified phase to pass;
a processing unit electrically connected with the image sensor and analyzing the sensed image to obtain the coded information of the coding pattern; and
a communication interface electrically connected with the processing unit and used to transmit the coded information to an external electronic device.

10. The user input system according to claim 9, wherein the phase compensation layer is realized by a liquid crystal polymer, a multilayer structure, a nanograting structure, or segmented fiber.

11. The user input system according to claim 9, wherein the coding pattern has a plurality of pattern units, and the pattern units are lines, circles, ellipses, polygons, curves, or a combination thereof.

12. The user input system according to claim 9, wherein the optical film further comprises
a scattering layer disposed between the substrate and the phase compensation layer or disposed on the phase compensation layer for scattering the sensing light.

13. The user input system according to claim 12, wherein the scattering layer is realized by a roughened surface structure, a holographic structure, or scattering tiny particles.

14. The user input system according to claim 9, wherein the optical film further comprises
a coating layer covering the phase compensation layer or the sensing surface of the substrate, and having at least one of a hard coating property, an anti-glare property, an anti-reflection property, an anti-fingerprint property, a hydrophobicity property, and an anti-electrostatic property.

15. The user input system according to claim 9, wherein the optical film further comprises
an adhesive layer disposed on an outermost side of the back surface of the substrate.

16. The user input system according to claim 15, wherein the adhesive layer includes a light absorption material able to absorb or scatter a light with a specified range of wavelengths.

17. The user input system according to claim 9, wherein the light source module includes a light emitting unit and a polarizer; the polarizer is disposed on a light output side of the light emitting unit; the polarizer converts a light emitted by the light emitting unit into the sensing light with the specified phase.

18. The user input system according to claim 9 further comprising
a display device disposed on the back side of the optical film and electrically connected with the external electronic device.
